(19) United States
(12) Patent Application Publication
(10) Pub. No.: US 2023/0101992 A1
(43) Pub. Date: Mar. 30, 2023

(54) SPECIFIC SEPARATOR COMPRISING AN ELECTROLYTE FOR AN ELECTROCHEMICAL ACCUMULATOR AND ELECTROCHEMICAL CELL FOR AN ACCUMULATOR COMPRISING SUCH A SEPARATOR

(71) Applicants: COMMISSARIAT À L'ÉNERGIE ATOMIQUE ET AUX ÉNERGIES ALTERNATIVES, Paris (FR); SOLVAY, Bruxelles (BE)

(72) Inventors: Jérémie Salomon, Grenoble (FR); Benjamin Amestoy, Grenoble (FR); Gaëlle Besnard, Grenoble (FR); Marc-David Braida, Bry Sur Marne (FR); Hélène Rouault, Grenoble (FR)

(21) Appl. No.: 17/757,425

(22) PCT Filed: Nov. 30, 2020
(86) PCT No.: PCT/FR2020/052219

§ 371 Date: Jun. 15, 2022

(30) Foreign Application Priority Data
Dec. 18, 2019 (FR) FR1914768

(51) Int. Cl. H01M 10/0565; H01M 50/411

(52) U.S. Cl. CPC H01M 10/0565; H01M 50/411

(57) ABSTRACT

The invention relates to a separator for an electrochemical accumulator comprising a substrate provided with cavities, said substrate consisting of one or more polymers, at least one of which is a polymer from the family of polyaryletherketones, all or part of said cavities being filled in whole or in part by a gelled polymer electrolyte.

### TECHNICAL FIELD

The present invention relates to a specific separator comprising an electrolyte and, more specifically, an electrolyte trapped in a polymer matrix and forming a gel therewith, this separator being intended to be incorporated into electrochemical accumulators.

The general field of the invention can be defined as that of the energy storage devices, in particular, that of the electrochemical accumulators.

### STATE OF THE ART

The electrochemical accumulators operate on the principle of electrochemical cells capable of delivering an electric current thanks to the presence, in each of them, of a pair of electrodes (respectively, a positive electrode and a negative electrode) separated by an electrolyte, the electrodes comprising specific materials capable of reacting according to a redox reaction, whereby there is production of electrons at the origin of the electric current and production of ions which will circulate from one electrode to the other through an electrolyte.

Among the accumulators subscribing to this principle, the accumulators operating on the principle of insertion-deinsertion of a metal element intervening at the electrodes (and more specifically, the active materials of the electrodes) and known under the terminology of metal-ion accumulators (for example, Li-ion, Na-ion, K-ion, Ca-ion, Mg-ion or Al-ion) have supplanted the other accumulator types, such as lead-acid accumulators, Ni-MH accumulators, in particular for their performance in terms of energy densities. Indeed, the metal-ion accumulators, such as Li-ion accumulators, allow, in particular, obtaining weight and volume energy densities (which may be greater than 180 Wh.kg⁻¹) which are significantly higher than those of the Ni-MH and Ni—Cd accumulators (which can range from 50 and 100 Wh.kg⁻¹) and Acid-lead (which can range from 30 to 35 Wh.kg⁻¹).

From a functional point of view, in metal-ion accumulators, the reaction at the origin of the current production (that is to say, when the accumulator is in discharge mode) involves the transfer, via a metal ion conductive electrolyte, metal cations from a negative electrode which are inserted into the acceptor network of the positive electrode, while electrons from the reaction at the electrode negative will supply the external circuit, to which the positive and negative electrodes are connected.

More specifically, in the case of a Li-ion accumulator, the positive electrode may comprise, as lithium insertion materials, lithium-based phosphate compounds (for example, LiFePO₄), a lithiated manganese oxide, optionally substituted (such as LiMn₂O₄), a material based on lithium-nickel-manganese-cobalt LiNiₓMn_{y}Co_{z}O₂ with x+y+z=1 (also known by the abbreviation NMC), such as LiNi_{1/3}Mn_{1/3}Co_{1/3}O₂ or LiNi_{0,6}Mn_{0,2}Co_{0,2}O₂ or a material based on lithium-nickel-cobalt-aluminium LiNiₓCo_{y}Al_{z}O₂ with x+y+z=1 (also known by the abbreviation NCA), such as LiNi_{0,8}Co_{0,15}Al_{0,05}O₂.

The negative electrode may comprise, as lithium insertion materials, a carbon material, such as graphite, a silicon-based compound, such as a silicon carbide SiC, a silicon-based composite or a silicon oxide, a lithium titanium oxide, such as Li₄TiO₅O₁₂ or a lithium-germanium alloy, or else a mixture of several of these lithium insertion materials such as a mixture comprising graphite and a silicon-based compound.

As mentioned above, between the negative electrode and the positive electrode, an electrolyte is arranged, which will allow the displacement of ions (generally derived from a metal salt present in the electrolyte) from the positive electrode towards the negative electrode when charging and conversely when discharging.

This electrolyte may be in a liquid form and conventionally comprises one or more organic solvents (for example, a mixture of carbonate solvents), in which is (are) dissolved one or more metal salts (for example, one or more lithium salts, when the accumulator is a lithium-ion accumulator).

However, the use of a liquid electrolyte has a number of drawbacks from the following:
the problem of leakage of the liquid electrolyte out of the cell;
the sensitivity of such an electrolyte to humidity and its harmful nature in contact with ambient air;
the possibility that the liquid electrolyte reacts chemically with the oxygen of the active material of the positive electrode, when a thermal runaway occurs in the cell comprising this electrolyte, thus being able to generate a significant gas volume, the consequence of which can be the inflammation or even the explosion of the cell.

In order to overcome these drawbacks, an alternative consists in eliminating the use of a liquid electrolyte by replacing it, for example, with the following solutions:
a lithium ion conductive glass or ceramic being in a purely solid form, for example, a thin layer deposited by chemical vapor deposition (CVD) such as a LIPON layer, or a layer of a composite material comprising a polymer matrix, for example made of polyvinylidene fluoride, and a filler consisting of a lithiated oxide, such as Li₇La₃Zr₂O₁₂;
a dry polymer solid electrolyte composed of a polymer of the polyethylene oxide (PEO) type and a lithium salt, for example lithium trifluorosulfonylimidide (LiTFSI).

However, these different solutions all have, currently, a certain number of drawbacks.

Concerning the use of lithium ion conductive glass or ceramic, this requires very complex implementation or synthesis techniques to be developed in an industrial context, which may prove to be prohibitive for large-scale production of accumulators.

Concerning solid dry polymer electrolytes, their ionic conductivity is generally less than 10⁻⁵ S.cm⁻¹, whereas, for a conventional liquid electrolyte, the ionic conductivity is in the range of 10⁻³ S.cm⁻¹, even 10⁻² S.cm⁻¹ at ambient temperature. As a result, it may prove necessary to use the accumulators including a dry polymer electrolyte at temperatures higher than ambient temperature, for example, a temperature ranging from 60 to 80° C. to promote the diffusion of lithium ions within the electrolyte.

In order to overcome the drawbacks associated with the use of a liquid electrolyte, electrolytes in the form of a gel, called gelled electrolytes, have been developed in which a liquid electrolyte is confined within a membrane conventionally formed of one or more polymers capable of gelling on contact with this liquid electrolyte. More specifically, these gelled electrolytes comprise a polymer matrix (in which case they can be qualified as gelled polymer electrolytes), a liquid phase and an ion-conductive salt (for example, a lithium salt, when the accumulator is a lithium accumulator) and, optionally, one or more fillers, which may be inorganic. As examples of polymer matrices entering into the constitution of the gelled electrolytes, it is known to use polyvinylidene fluoride (known by the abbreviation PVDF) or a derivative thereof, such as a copolymer derived from the copolymerisation of vinylidene fluoride and hexafluoropropylene (known by the abbreviation PVDF-HFP), a polyacrylonitrile (known by the abbreviation PAN), a poly(methyl methacrylate) (known by the abbreviation PMMA), these polymers having the ability to form a gel in the presence of a liquid electrolyte containing an ion-conductive salt, such as a lithium salt. The ionic conduction mechanism is governed by the diffusion of salt ions into the gelled phase.

The gelled polymer electrolytes generally have an ionic conductivity in the range of 10⁻³ S.cm⁻¹, which represents substantially ten times the conductivity of a dry ionic polymer electrolyte. However, as attested in J. Mater. Chem. A, 2016, 4, 10038, the mechanical properties are low, which makes them difficult to handle, in particular during the manufacture of the accumulators comprising them, in particular, including during the assembly step which consists of stacking and winding, according to the desired final format of the cell, the gelled polymer electrolyte with the positive electrode and the negative electrode, the gelled polymer electrolyte being interposed between two electrodes.

A solution which is proposed to improve the mechanical properties of the gelled polymer electrolytes can be to incorporate inorganic fillers, such as SiO₂, TiO₂, Al₂O₃ or else cellulosic fibres thereto, these gelled polymer electrodes being however difficult to manufacture.

In view of what already exists, the inventors have set themselves the objective of proposing a new type of separator incorporating a gelled polymer electrolyte and having high mechanical properties compatible with the conventional methods for manufacturing electrochemical accumulators, in particular during spiraling or stacking and being able to be manufactured simply and quickly, without negative effect on the ionic conductivity.

### DISCLOSURE OF THE INVENTION

Thus, the invention relates to a separator for an electrochemical accumulator comprising a substrate provided with cavities, said substrate consisting of one or more polymers, at least one of which is a polymer from the family of polyaryletherketones, all or part of said cavities being filled in whole or in part by a gelled polymer electrolyte.

The term separator means an element or interface intended to ensure, in this context, the separation between a positive electrode and a negative electrode, this element or interface further comprising the electrolyte.

The term electrochemical accumulator, means a system which generates and/or stores energy based on a technique of reversible conversion of electrochemical energy, this type of system including primary batteries (corresponding to non-rechargeable single-use batteries) or secondary batteries (corresponding to rechargeable batteries).

Thanks to the presence of these specific substrates, the separators of the invention have:
excellent mechanical properties, such as tensile strength (which can be in the range of 100 N/mm2 according to the DIN 53455 standard) while not altering the electrochemical performance of the gelled polymer electrolyte;
excellent chemical resistance, these substrates being chemically inert relative to the constituents which are conventionally used in the electrochemical accumulators and in particular relative to gelled polymer electrolytes, which allows stability over time of the mechanical and physical properties.

As mentioned above, the substrate is a substrate provided with cavities, said substrate consisting of one or more polymers, at least one of which is a polymer from the family of polyaryletherketones.

Advantageously, the substrate consists only of one or more polymers from the family of polyaryletherketones and, even more specifically, of a single polymer from the family of polyaryletherketones.

Conventionally, polyaryletherketones comprise, in their skeleton, aromatic groups, such as phenylene groups, bonded to each other by oxygen atoms and aromatic groups, such as phenylene groups, bonded to each other by carbonyl groups —CO—.

In general, a polyaryletherketone can also be defined as a polymer comprising repeating units, of which more than 50 mol % of said repeating units are repeating units comprising an —Ar—C(O)—Ar′-group, wherein Ar and Ar′, identical or different from each other, are aromatic groups, these units being referred to hereinafter as units (R_{pAEK}).

Preferably, the units (R_{pAEK}) are selected from the group consisting of the units of formulas (J-A) to (J-O) below:

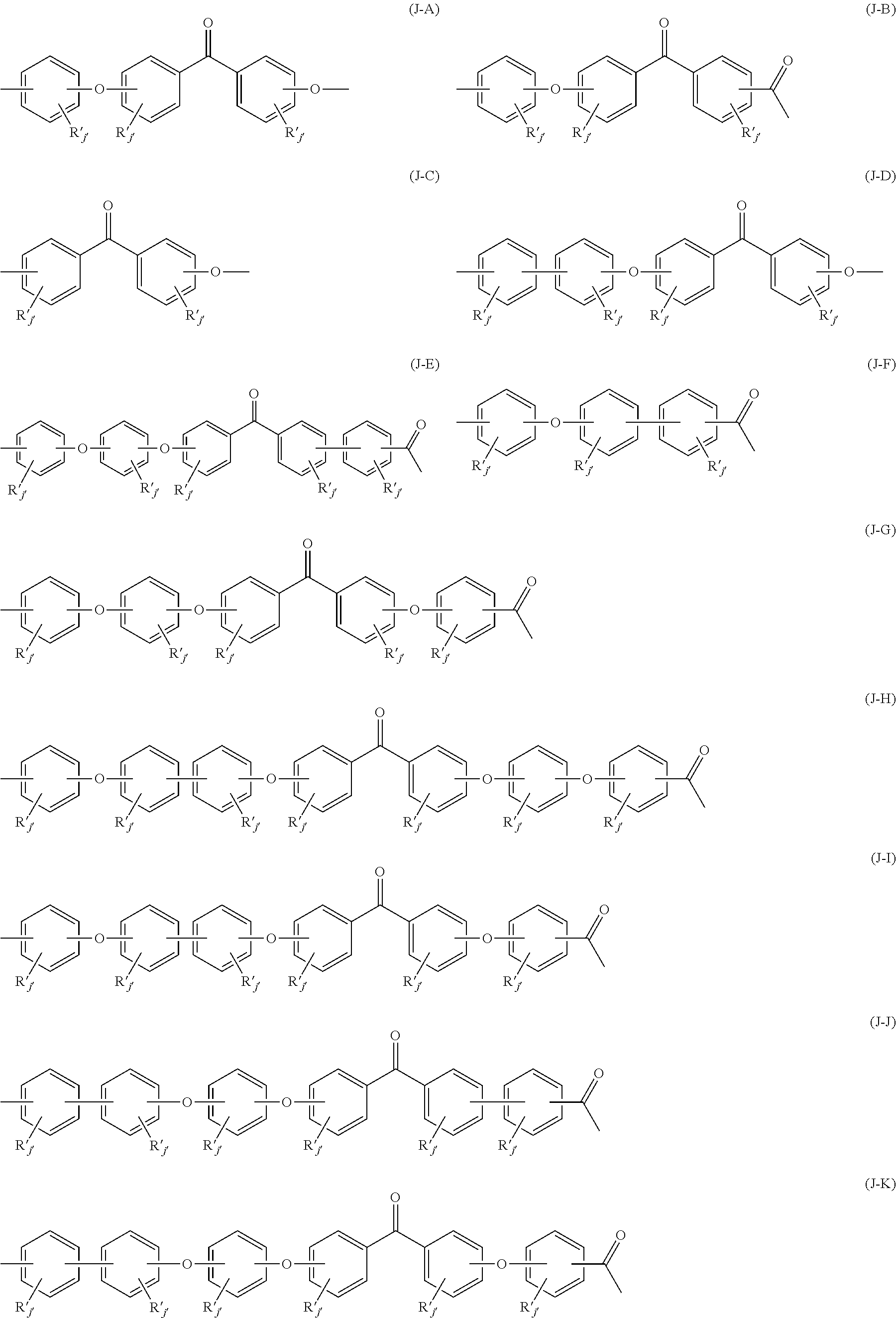

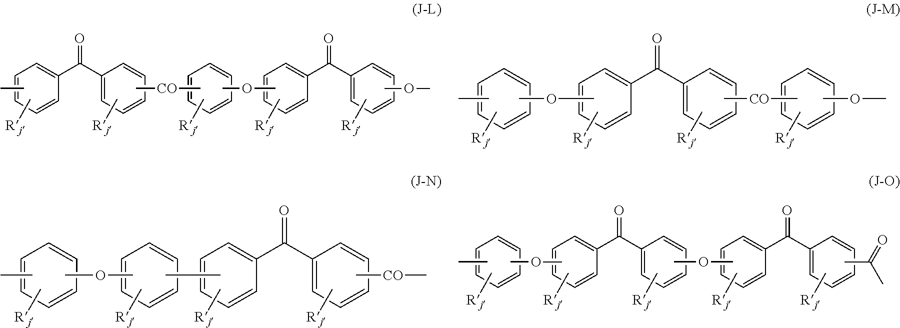

wherein:
each R′, identical or different, is selected from the group consisting of halogen atoms, alkyl, alkylvinyl, alkenyl, alkynyl, aryl, ether, thioether, carboxylic acid, ester, amide, imide, sulphonate, phosphonate, alkali or alkaline earth metal alkylphosphonate, amine and quaternary ammonium groups;
j′ is zero or an integer ranging from 1 to 4.

In the repeating units (R_{pAEK}), the corresponding phenylene groups may have 1,2-, 1,4- or 1,3 bonds to groups other than the R′ substituents in the unit. Preferably, these phenylene groups have a 1,3- or 1,4- bond, and more preferably they have a 1,4- bond.

Moreover, in the repeating units (R_{pAEK}), j′ is preferably equal to zero, which means that the phenylene groups do not have other substituents than those which allow the bonding in the main chain of the polymer.

More specifically and, preferably, the repeating units (R_{pAEK}) are selected from those of formulas (J′-A) to (J′-O) below:

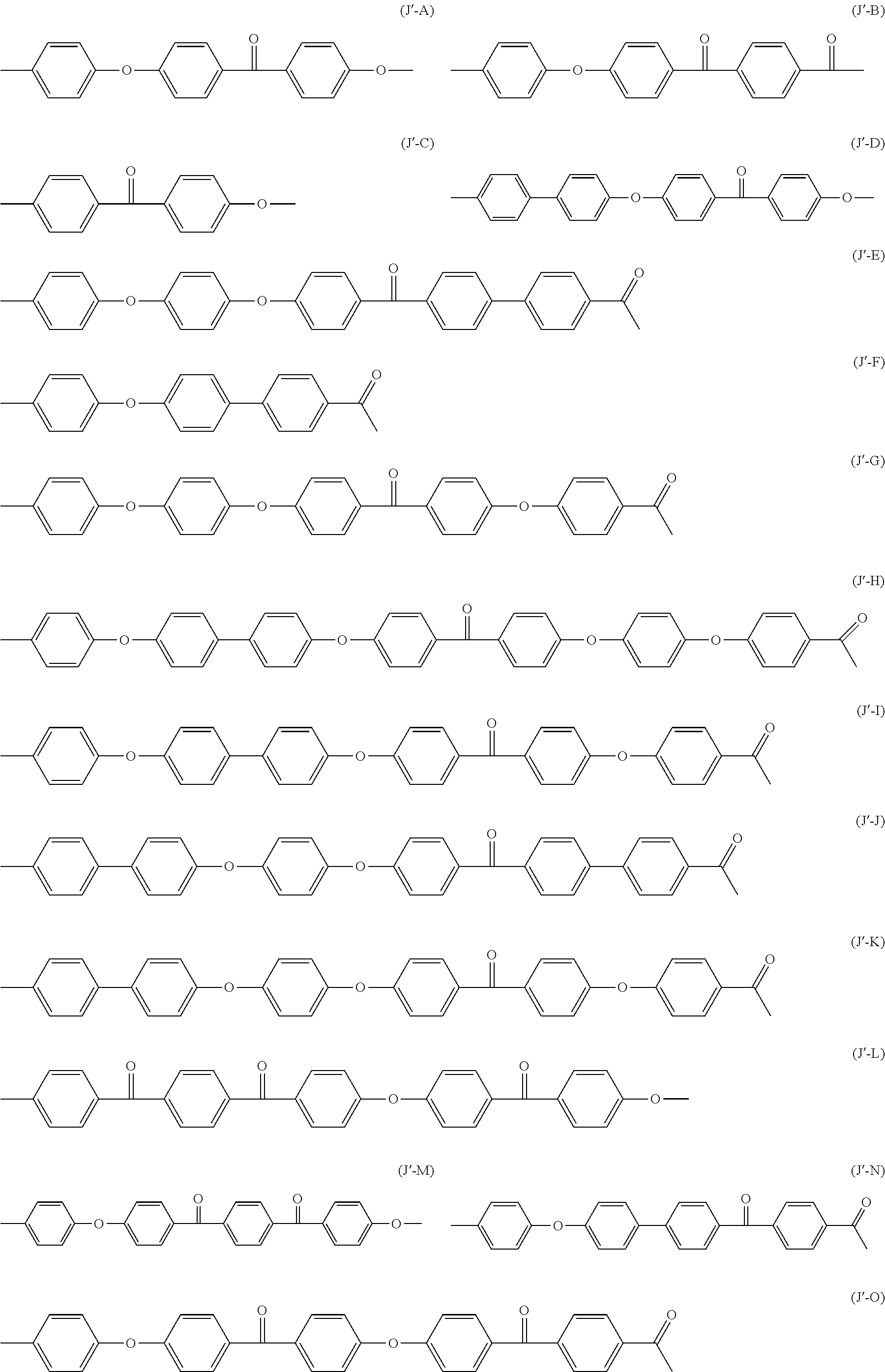

In polyaryletherketones, as described above, preferably more than 60 mol %, more preferably more than 80 mol % and even more preferably more than 90 mol % of the repeating units are repeating units (R_{PAEK}), as specified above.

It is further preferred that essentially all repeating units of polyaryletherketone are repeating units (R_{pAEK}), as described above. Defects in the polymer chain, or very limited amounts of other units could be present, provided that the latter do not substantially modify the properties of the concerned polyaryletherketone.

The polyaryletherketone may in particular be a homopolymer or a random, alternating or block copolymer. When the polyaryletherketone is a copolymer, it may in particular contain:
(i) repeating units (R_{pAEK}) of at least two different formulas selected from formulas (J-A) to (J-O); or
(ii) repeating units (R_{pAEK}) according to one or more of the formulas (J-A) to (J-O) and repeating units (R*_{pAEK}) different from the units (R_{pAEK}), described above.

As explained in more detail below, polyaryletherketone can be a polyetheretherketone [polymer (PEEK), below]. Alternatively, the polyaryletherketone can be a polyetherketoneketone [polymer (PEKK), below], a polyetherketone [polymer (PEK), below], a polyetheretherketoneketone [polymer (PEEKK), below], or a polyetherketoneetherketoneketone [polymer (PEKEKK), below].

The polyaryletherketone can also be a mixture composed of at least two different polyaryletherketones, which are preferably selected from the group consisting of a polymer (PEKK), a polymer (PEEK), a polymer (PEK), a polymer (PEEKK) and a polymer (PEKEKK), as defined below.

Within the scope of the present invention, the term “polymer (PEEK)” is used to designate any polymer of which more than 50 mol %, preferably more than 75 mol %, even more preferably more than 85 mol % and even more preferably more than 99 mol % of the repeating units are units (R_{pAEK}) of formula (J′-A) as defined above. The most preferred polymer (PEEK) is that in which all repeating units are repeating units of formula (J′-A) as defined above.

Within the scope of the present invention, the term “polymer (PEKK)” is used to designate any polymer of which more than 50 mol %, preferably more than 75 mol %, even more preferably more than 85 mol % and even more preferably more than 99 mol % of the repeating units are units (R_{PAEK}) of formula (J′-B) as defined above. The most preferred polymer (PEKK) is that in which all repeating units are repeating units of formula (J′-B) as defined above.

Within the scope of the present invention, the term “polymer (PEK)” is used to designate any polymer of which more than 50 mol %, preferably more than 75 mol %, even more preferably more than 85 mol % and even more preferably more than 99 mol % of the repeating units are units (R_{PAEK}) of formula (J′-C) as defined above. The most preferred polymer (PEK) is that in which all repeating units are repeating units of formula (J′-C) as defined above.

Within the scope of the present invention, the term “polymer (PEEKK)” is used to designate any polymer of which more than 50 mol %, preferably more than 75 mol %, even more preferably more than 85 mol % and even more preferably more than 99 mol % of the repeating units are units (R_{PAEK}) of formula (J′-M) as defined above. The most preferred polymer (PEEKK) is that in which all repeating units are repeating units of formula (J′-M) as defined above.

Within the scope of the present invention, the term “polymer (PEKEKK)” is used to designate any polymer of which more than 50 mol %, preferably more than 75 mol %, even more preferably more than 85 mol % and even more preferably more than 99 mol % of the repeating units are units (R_{PAEK}) of formula (J′-L) as defined above. The most preferred polymer (PEKEKK) is that in which all repeating units are repeating units of formula (J′-L) as defined above.

Excellent results within the scope of the present invention have been obtained when the polyaryletherketone is a homopolymer (PEEK), namely a polymer in which essentially all repeating units are units of formula (J′-A), and in which defects of the polymer chain and/or very limited amounts (<1 mol % with relative to all units) of other units could be present, without the latter being able to significantly change the properties of this homopolymer (PEEK).

Among the examples of polyaryletherketones available commercially, mention may in particular be made of the polyetheretherketone KETASPIRE® available from Solvay Specialty Polymers USA, LLC.

Preferably, the substrate comprises (or even consists of) a polyetheretherketone (known by the abbreviation PEEK), this type of polymer having the particularity of having an excellent tensile strength (in the range of 100 N/mm² measured according to the standard DIN 53455) and lends itself to being shaped into an open structure to accommodate the gelled polymer electrolyte. Preferably, the substrate is not an ionic conductor.

The substrate preferably has a porosity of at least 70%, more preferably of at least 75% and, even more preferably, of at least 85% by volume relative to the total volume of said substrate.

In the context of the present invention, the term “porosity” is used to designate the volumetric fraction of cavities relative to the total volume of the substrate. The porosity is determined by knowing the experimental density of the substrate and the density of the constituent polymer of the substrate and by the following relationship:

Porosity=(1-voluminal mass of substrate/density of the polymer)*100

From a structural point of view, the substrate may be in the form of a grid resulting from an interlacing of polymer strands, the grid possibly having a mesh of a square, circular, hexagonal, lozenge shape or any other shape.

Preferably, the substrate is in the form of a grid having a lozenge-shaped mesh, each lozenge possibly having a large diagonal ranging from 0.5 mm to 3 mm, preferably from 1 mm to 2 mm.

A photograph of a lozenge-shaped mesh grid which can be used for the separators of the invention is illustrated in FIG. 1 attached in the appendix.

The polymer strands can have a square, rectangular, circular, lozenge, hexagonal-shaped section or having any other shape with a preference for the polymer strands with a rectangular section.

The strands preferably have a cross-section of non-circular shape and a dimension ratio between the main axis of the cross-section and the secondary axis of the cross-section comprised between 1.5 and 15, in particular between 2 and 10. In these preferred strands, the main axis of the cross section has a length ranging from 0.1 mm to 1 mm, preferably from 0.1 mm to 0.3 mm; and/or the secondary axis of the cross section has a length ranging from 20 μm to 60 μm, preferably from 20 μm to 40 μm.

All or part of the cavities of the substrate are filled in whole or in part by the gelled polymer electrolyte, the gelled polymer electrolyte possibly further occupying all or part of the surface of the substrate in the form of a layer.

The gelled polymer electrolyte can be any type of gelled polymer electrolyte with or without an organic portion, as described in WO 2017/220312 and, preferably, the gelled polymer electrolyte can comprise:

(A) a matrix comprising:

(A-1) an organic portion comprising (or consisting of) at least one fluorinated polymer (F) comprising at least one repeating unit derived from the polymerisation of a fluorinated monomer and at least one repeating unit derived from the polymerisation of a monomer comprising at least one hydroxyl group, optionally in the form of a salt; and

(A-2) an inorganic portion formed, in whole or in part, of one or more oxides of at least one element M selected from Si, Ti and Zr and combinations thereof; and

(B) a liquid electrolyte confined or trapped within the matrix.

It is understood that the repeating unit(s) derived from the polymerisation of a fluorinated monomer and the repeating unit(s) derived from the polymerisation of a monomer comprising at least one hydroxyl group, optionally in the form of a salt, are chemically different repeating units and, in particular, the repeating unit(s) derived from the polymerisation of a fluorinated monomer do not comprise any hydroxyl group(s), optionally in the form of a salt.

For the fluorinated polymer (F), the repeating unit(s) derived from the polymerisation of a fluorinated monomer can be, more specifically, one or more repeating units derived from the polymerisation of one or more ethylenic monomers comprising at least one fluorine atom and optionally one or more other halogen atoms, examples of monomers of this type being the following:
C₂-C₈, perfluoroolefins, such as tetrafluoroethylene, hexafluoropropene (also known by the abbreviation HFP);
C₂-C₈, hydrogenated fluoroolefins, such as vinylidene fluoride, vinyl fluoride, 1,2-difluoroethylene and trifluoroethylene;
perfluoroalkylethylenes of formula CH₂═CHR¹, wherein R¹ is a C₁-C₆ perfluoroalkyl group;
C₁-C₆ fluoroolefins including one or more other halogen atoms (such as chlorine, bromine, iodine), such as chlorotrifluoroethylene;
(per)fluoroalkylvinylethers of formula CF₂═CFOR², wherein R² is a C₁-C₆ fluoro- or perfluoroalkyl group, such as CF₃, C₂F₅, C₃F₇;
monomers of formula CF₂═CFOR³, wherein R³ is a C₁-C₁₂ alkyl group, a C₁-C₁₂ alkoxy group or a C₁-C₁₂ (per)fluoroalkoxy group, such as a perfluoro-2-propoxypropyl group; and or
monomers of formula CF₂═CFOCF₂OR⁴, wherein R⁴ is a C₁-C₆ fluoro- or perfluoroalkyl group, such as CF₂, C₂F₅, C₃F₇ or a C₁-C₆ fluoro- or perfluoroalkoxy group, such as —C₂F₅—O—CF₃.

More particularly, the fluorinated polymer (F) can comprise, as repeating units derived from the polymerisation of a fluorinated monomer, a repeating unit derived from the polymerisation of a monomer from the class of C₂-C₈ perfluoroolefins, such as hexafluoropropene and a repeating unit derived from the polymerisation of a monomer from the class of C₂-C₈ hydrogenated fluoroolefins, such as vinylidene fluoride.

Still in relation to the fluorinated polymer (F), the repeating unit(s) derived from the polymerisation of a monomer comprising at least one hydroxyl group, optionally in the form of a salt, can be, more specifically, one or more repeating units derived from the polymerisation of a monomer of formula (I) below:

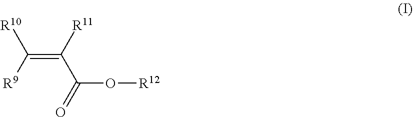

wherein R⁹ to R¹¹ represent, independently of each other, a hydrogen atom or a C₁-C₃ alkyl group and R¹² is a C₁-C₅ hydrocarbon group comprising at least one hydroxyl group, examples of monomers of this type being hydroxyethyl (meth)acrylate monomers, hydroxypropyl (meth)acrylate monomers.

More particularly, the fluorinated polymer (F) may comprise, as repeating unit derived from the polymerisation of a monomer comprising at least one hydroxyl group, a repeating unit derived from the polymerisation of one of the monomers of the following formulas (II) to (IV):

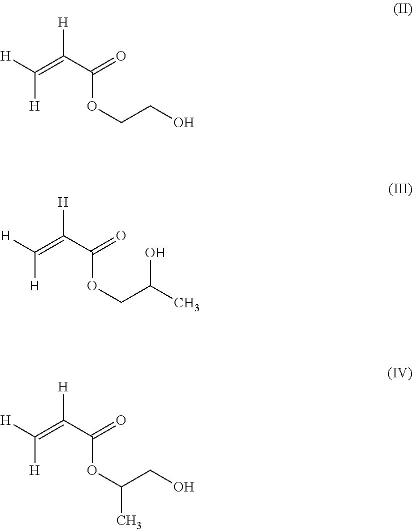

and, preferably a repeating unit derived from the polymerisation of the monomer of the aforementioned formula (II), this monomer corresponding to 2-hydroxyethyl acrylate (also known by the abbreviation HEA).

Thus, particular fluorinated polymers (F) which can be used within the scope of the invention to form the gelled polymer electrolyte can be polymers comprising, as repeating units derived from the polymerisation of a fluorinated monomer, a repeating unit derived from the polymerisation of a monomer from the class of C₂-C₈ perfluoroolefins, such as hexafluoropropene and a repeating unit derived from the polymerisation of a monomer from the category of C₂-C₈ hydrogenated fluoroolefins, such as vinylidene fluoride, and comprising, as repeating unit derived from the polymerisation of a monomer comprising at least one hydroxyl group, a repeating unit derived from the polymerisation of a monomer of the previously defined formula (II) and, even more specifically, a polymer whose aforementioned repeating units are derived from the polymerisation:
at least 70 mol % of a C₂-C₈ hydrogenated fluoroolefin, preferably, vinylidene fluoride;
from 0.1 to 15 mol % of a C₂-C₈ perfluoroolefin, preferably hexafluoropropene; and
from 0.01 to 20 mol % of a monomer of formula (I), preferably 2-hydroxyethyl acrylate.

Advantageously, the inorganic portion which is at least partially formed of one or more oxides of at least one element M selected from Si, Ti and Zr and combinations thereof is, in whole or in part, chemically bonded to the organic portion via hydroxyl groups.

Gelled polymer electrolytes comprising a matrix, in which the organic portion is chemically bonded to the inorganic portion, as described above, are in particular described in the document WO 2013/072216.

The liquid electrolyte trapped within the matrix is, conventionally, an ion-conductive electrolyte, which can comprise (or even consists of) at least one organic solvent, at least one metal salt and optionally a compound from the family of vinyl compounds.

The organic solvent(s) can be carbonate solvents and, more specifically:
cyclic carbonate solvents, such as ethylene carbonate (symbolized by the abbreviation EC), propylene carbonate (symbolized by the abbreviation PC), butylene carbonate, vinylene carbonate, fluoroethylene carbonate, fluoropropylene carbonate and mixtures thereof;
linear carbonate solvents, such as diethyl carbonate (symbolized by the abbreviation DEC), dimethyl carbonate (symbolized by the abbreviation DMC), ethyl methyl carbonate (symbolized by the abbreviation EMC) and mixtures of these.

The organic solvent(s) can also be ester solvents (such as ethyl propionate, n-propyl propionate), nitrile solvents (such as acetonitrile) or ether solvents (such as dimethyl ether, 1,2-dimethoxyethane).

The organic solvent(s) can also be ionic liquids, that is to say, conventionally, compounds formed by the combination of a cation and an anion, which is in the liquid state at temperatures below 100° C. under atmospheric pressure.

More specifically, the ionic liquids can comprise:
a cation selected from imidazolium, pyridinium, pyrrolidinium, piperidinium cations, said cations being optionally substituted by at least one alkyl group comprising 1 to 30 carbon atoms;
an anion selected from halide anions, perfluorinated anions, imidazole anions, imide anions, phosphate anions, borate anions.

Even more specifically, the cation can be selected from the following cations:
a pyrrolidinium cation of the following formula (V):

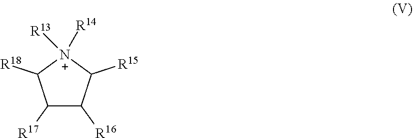

wherein R¹³ and R¹⁴ represent, independently of each other, a C₁-C₈ alkyl group and R¹⁵, R¹⁶, R¹⁷ and R¹⁸ represent, independently of each other, a hydrogen atom or a C₁-C₃₀ alkyl group, preferably a C₁-C₁₈ alkyl group, more preferably a C₁-C₈ alkyl group;
a piperidinium cation of the following formula (VI):

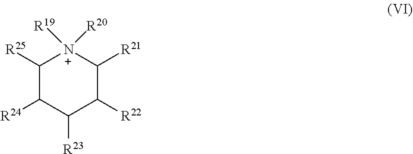

wherein R¹⁹ and R²⁰ represent, independently of each other, a C₁-C₈ alkyl group and R²¹, R²², R²³, R²⁴ and R²⁵ represent, independently of each other, a hydrogen atom or a C₁-C₃₀ alkyl group, preferably a C₁-C₁₈ alkyl group, more preferably a C₁-C₈ alkyl group.

In particular, the positively charged cation can be selected from the following cations:
a pyrrolidinium cation of the following formula (V-A):

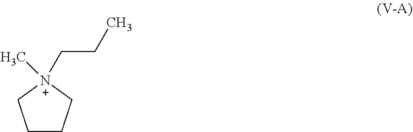

a piperidinium cation of the following formula (VI-A):

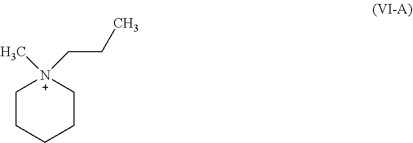

Specifically, the negatively charged anion can be selected from:
4,5-dicyano-2-(trifluoromethyl)imidazole (known by the abbreviation TDI);
bis(fluorosulfonyl)imide (known by the abbreviation FSI);
bis(trifluoromethylsulfonyl)imide of formula (SO₂CF₃)₂N⁻;
hexafluorophosphate of formula PF₆⁻;
tetrafluoroborate of formula BF₆⁻;
oxaloborate of the following formula (VII):

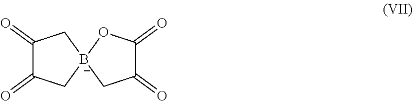 [SMILES: O=C1C[B-]2(CC1=O)CC(=O)C(=O)O2]

A specific ionic liquid which can be used according to the invention may be an ionic liquid composed of a cation of formula (VI-A) as defined above and an anion of formula (SO₂CF₃)₂N⁻, PF₆⁻ or BF₄⁻.

The metal salt or salts may be selected from the salts of the following formulas: Mel, Me(PF₆)ₙ, Me(BF₄)n, Me(ClO₄)ₙ, Me(bis(oxalato)borate)ₙ (which may be designated by abbreviation Me(BOB)ₙ), MeCF₃SO₃, Me[N(FSO₂)₂]ₙ, Me[N(CF₃SO₂)₂]ₙ, Me[N(C₂F₅SO₂)₂]ₙ, Me[N(CF₃SO₂)(R_{F}SO₂)]ₙ, where R_{F} is a —C₂F₅, —C₄F₉ or —CF₃OCF₂CF₃, Me(AsF₆)ₙ, Me[C(CF₃SO₂)₃]ₙ, Me₂Sₙ, Me(C₆F₃N₄) group (C₆F₃N₄ corresponding to 4,5-dicyano-2-(trifluoromethyl)imidazole and, when Me is Li, the salt corresponds to lithium 4,5-dicyano-2-(trifluoromethyl)imidazole, this salt being known by the abbreviation LiTDI), in which Me is a metal element and, preferably, a metal transition element, an alkaline element or an alkaline-earth element and, more preferably, Me is Li (in particular, when the accumulator of the invention is a lithium-ion or lithium-air accumulator), Na (in particular, when the accumulator is a sodium-ion accumulator), K (in particular, when the accumulator is a potassium-ion accumulator), Mg (in particular, when the accumulator is a Mg-ion accumulator), Ca (in particular, when the accumulator is a calcium-ion accumulator) and Al (in particular, when the accumulator is a aluminum-ion) and n corresponds to the degree of valence of the metal element Me (typically, 1, 2 or 3).

When Me is Li, the salt is preferably LiPF₆.

The concentration of the metal salt in the liquid electrolyte is advantageously at least 0.01 M, preferably at least 0.025 M and more preferably at least 0.05 M and advantageously at most 5 M, preferably at most 2 M and more preferably at most 1 M.

Furthermore, the liquid electrolyte may comprise an additive belonging to the class of vinyl compounds (it being understood that this additive is different from the carbonate solvent(s) included, where applicable, in the electrolyte), such as vinylene carbonate or fluoroethylene carbonate, it being possible for these specific additives possibly being included in the electrolyte at a content not exceeding, respectively, 5% by mass and 10% by mass of the total mass of the electrolyte.

A liquid electrolyte which can be used in the separators of the invention, in particular when it is a lithium-ion accumulator, is an electrolyte comprising a mixture of carbonate solvents (for example, a mixture of cyclic carbonate solvents, such as a mixture of ethylene carbonate and propylene carbonate and present, for example, in identical volume or a mixture of cyclic carbonate solvents and linear carbonate solvent(s), such as a mixture of ethylene carbonate, propylene carbonate and dimethyl carbonate), a lithium salt, for example, LiPF₆ (for example, at a concentration of 1M) and optionally an additive, such as vinylene carbonate (for example, present at 2% by mass relative to the total mass of the liquid electrolyte) or fluoroethylene carbonate (for example, present at 10% by mass relative to the total mass of liquid electrolyte).

The separators of the invention are intended to be incorporated into electrochemical accumulators and, more specifically, to ensure the physical separation and the ionic conduction within an electrochemical cell of an accumulator between a positive electrode and a negative electrode.

Also, the invention also relates to an electrochemical cell for an electrochemical accumulator comprising a positive electrode, a negative electrode and a separator in accordance with the invention which is interposed between the positive electrode and the negative electrode.

The term “positive electrode” means, conventionally, in what precedes and what follows, the electrode which acts as cathode, when the accumulator delivers current (that is to say when it is in the process of discharging) and which acts as an anode when the accumulator is in the process of charging.

The term “negative electrode” means, conventionally, in what precedes and what follows, the electrode which acts as anode, when the accumulator delivers current (that is to say when it is in the process of discharging) and which acts as a cathode, when the accumulator is in the process of charging.

Each of the electrodes includes, conventionally, an active electrode material, namely a material capable of inserting and desinserting, in the structure thereof, metal ions, such as alkaline ions (for example, lithium ions, when the accumulator is a lithium accumulator, sodium ions, when the accumulator is a sodium accumulator, or potassium ions, when the accumulator is a potassium accumulator), alkaline-earth ions (for example, magnesium ions, when the accumulator is a magnesium accumulator), calcium ions, when the accumulator is a calcium accumulator), metal ions (for example aluminum ions, when the accumulator is an aluminium-ion accumulator).

The nature of the active material depends of course on its destination, namely whether it is intended for a positive electrode or a negative electrode.

By way of examples of active electrode materials likely to enter into the constitution of a positive electrode of a lithium accumulator, mention may be made of:
metal chalcogenides of formula LiMQ₂, wherein M is at least one metal element selected from the metal elements, such as Co, Ni, Fe, Mn, Cr, V, Al and Q is a chalcogen, such as 0 or S, the preferred metal chalcogenides being those of formula LiMO₂, with M being as defined above, such as, preferably, LiCoO₂, LiNiO₂, LiNiₓCo₁₋ₓO₂ (with 0<x<1), a material based on lithium-nickel-manganese-cobalt LiNiₓMn_{y}Co_{z}O₂ with x+y+z=1 (also known by the abbreviation NMC), such as LiNi_{1/3}Mn_{1/3}Co_{1/3}O₂, or a material based on lithium-nickel-cobalt-aluminum LiNiₓCo_{y}Al_{z}O₂ with x+y+z=1 (also known by the abbreviation NCA), such as LiNi_{0.8}Co_{0.15}Al_{0.05}O₂;
chalcogenides of spinel structure, such as LiMn₂O₄;
lithiated or partially lithiated materials of formula M₁M₂(JO₄)_{f}E_{1-f}, wherein M₁ is lithium, which may be partially substituted by another alkaline element up to a substitution rate of less than 20%, M₂ is a transition metal element of a degree of oxidation +2 selected from Fe, Mn, Ni and combinations thereof, which may be partially substituted by one or more other additional metal elements of degree(s) of oxidation between +1 and +5 up to a substitution rate of less than 35%, JO₄ is an oxyanion wherein J is selected from P, S, V, Si, Nb, Mo and combinations thereof, E is a fluoride, hydroxide or chloride anion, f is the molar fraction of the oxyanion JO₄ and is generally comprised between 0.75 and 1 (including 0.75 and 1).

More specifically, lithiated or partially lithiated materials can be phosphorus-based (which means, in other words, that the oxyanion corresponds to formula PO₄) and can have an ordered or modified olivine-type structure.

Lithiated or partially lithiated materials can correspond to the specific formula Li₃₋ₓM′_{y}M″_{2-y}(JO₄)₃, wherein 0≤x≤3, 0≤y≤2, M′ and M″ represent identical or different metal elements, at least one of M′ and M″ being a transition metal element, JO₄ is preferably PO₄, which may be partially substituted by another oxyanion with J being selected from S, V, Si, Nb, Mo and combinations thereof.

The lithiated or partially lithiated materials can have the formula Li(FeₓMn₁₋ₓ)PO₄, where 0≤x≤1 and, preferably, x is equal to 1 (which means, in other words, that the corresponding material is LiFePO₄).

By way of examples of active electrode materials likely to enter into the constitution of a negative electrode of a lithium accumulator, mention may be made of:
carbon materials, such as graphitic carbon capable of intercalating lithium which may exist, typically, in the form of a powder, flakes, fibres or spheres (for example, mesocarbon microbeads);
composite materials based on carbon materials comprising silicon Si or silicon oxide SiOₓ, such as the graphitic carbon/silicon C—Si or graphitic carbon/silicon oxide C—SiOₓ compounds, the graphitic carbon possibly being itself a mixture of one or more carbons capable of intercalating lithium;
metal lithium;
lithium alloys, such as those described in U.S. Pat. No. 6,203,944 and/or WO 00/03444;
lithiated titanium oxides, such as an oxide of formula Li₍₄₋ₓ₎MₓTi₅O₁₂ or Li₄M_{y}Ti_{(5-y)}O₁₂ wherein x and y range from 0 to 0.2, M represents an element selected from Na, K, Mg, Nb, Al, Ni, Co, Zr, Cr, Mn, Fe, Cu, Zn, Si and Mo, a specific example being Li₄Ti₅O₁₂, these oxides being lithium insertion materials with a low level of physical expansion after inserting lithium;
non-lithiated titanium oxides, such as TiO₂;
oxides of formula M_{y}Ti_{(5-y)}O₁₂ wherein y ranges from 0 to 0.2 and M is an element selected from Na, K, Mg, Nb, Al, Ni, Co, Zr, Cr, Mn, Fe, Cu, Zn, Si and Mo;
lithium-germanium alloys, such as those comprising crystalline phases of formula Li_{4.4}Ge.

Furthermore, whether for the positive electrode or the negative electrode, it may comprise electron-conducting additives, that is to say additives likely of give the electrode, in which they are incorporated, an electronic conductivity, these additives possibly being, for example, carbon materials such as carbon black, carbon nanotubes, carbon fibres (in particular, the carbon fibres obtained in the vapor phase known under the abbreviation VGCF), graphite in powder form, graphite fibres and mixtures thereof.

However, when a negative electrode includes, as active material, carbon materials, such as graphite, the negative electrode may advantageously be devoid of electron-conducting additive(s).

The positive electrode and the negative electrode may comprise, in addition to the aforementioned ingredients, a liquid electrolyte trapped or confined within a polymer matrix, which liquid electrolyte advantageously meets the same specific characteristics as those set out above in subject of the separator, in terms of ingredients (organic solvents, salts, concentrations, etc.), such electrodes thus constituting gelled electrodes. The resultant between the polymer matrix, the liquid electrolyte, the active material and possibly the electron-conducting additives form a composite material.

The polymer matrix may be made of at least one gelling polymer (FF), the gelling polymer(s) (FF) being selected from fluorinated polymers comprising at least one repeating unit derived from the polymerisation of a fluorinated monomer and, preferably, at least one repeating unit derived from the polymerisation of a monomer comprising at least one carboxylic acid group, optionally in the form of a salt.

It is understood that the repeating unit(s) derived from the polymerisation of a fluorinated monomer and, where appropriate, the repeating unit(s) derived from the polymerisation of a monomer comprising at least one carboxylic acid group, optionally in the form of a salt, are chemically different repeating units and, in particular, the repeating unit(s) derived from the polymerisation of a fluorinated monomer do not comprise any carboxylic acid group(s), optionally in the form of a salt.

For the gelling polymers (FF), the repeating unit(s) derived from the polymerisation of a fluorinated monomer can be, more specifically, one or more repeating units derived from the polymerisation of one or more ethylenic monomers comprising at least one fluorine atom and optionally one or more other halogen atoms, examples of monomers of this type being the following:
C₂-C₈ perfluoroolefins, such as tetrafluoroethylene, hexafluoropropene (also known by the abbreviation HFP);
C₂-C₈ hydrogenated fluoroolefins, such as vinylidene fluoride, vinyl fluoride, 1,2-difluoroethylene and trifluoroethylene;
perfluoroalkylethylenes of formula CH₂═CHR¹, wherein R¹ is a C₁-C₆ perfluoroalkyl group;
C₁-C₆ fluoroolefins including one or more other halogen atoms (such as chlorine, bromine, iodine), such as chlorotrifluoroethylene;
(per)fluoroalkylvinylethers of formula CF₂═CFOR², wherein R² is a C₁-C₆ fluoro- or perfluoroalkyl group, such as CF₃, C₂F₅, C₃F₇;
monomers of formula CF₂═CFOR³, wherein R³ is a C₁-C₁₂ alkyl group, a C₁-C₁₂ alkoxy group or a C₁-C₁₂ (per)fluoroalkoxy group, such as a perfluoro-2-propoxypropyl group; and or
monomers of formula CF₂=CFOCF₂OR⁴, wherein R⁴ is a C₁-C₆ fluoro- or perfluoroalkyl group, such as CF₂, C₂F₅, C₃F₇ or a C₁-C₆ fluoro- or perfluoroalkoxy group, such as —C₂F₅—O—CF₃.

More particularly, the gelling polymer(s) (FF) may comprise, as repeating unit(s) derived from the polymerisation of a fluorinated monomer, a repeating unit derived from the polymerisation of a monomer from the class of C₂-C₈ perfluoroolefins, such as hexafluoropropene and a repeating unit derived from the polymerisation of a monomer from the class of C₂-C₈ hydrogenated fluoroolefins, such as vinylidene fluoride.

The repeating unit(s) derived from the polymerisation of a monomer comprising at least one carboxylic acid group, optionally in the form of a salt, may more specifically be one or more repeating units derived from the polymerisation of a monomer of the following formula (VIII):

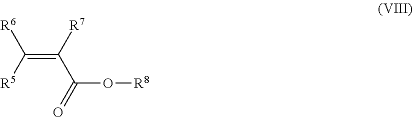

wherein R⁵ to R⁷ represent, independently of each other, a hydrogen atom or a C₁-C₃ alkyl group and R⁸ represents a hydrogen atom or a monovalent cation (for example, an alkaline cation, an ammonium cation), particular examples of monomers of this type being acrylic acid or methacrylic acid.

Specific gelling polymers (FF) that which can be used within the scope of the invention can be polymers comprising a repeating unit derived from the polymerisation of vinylidene fluoride, a repeating unit derived from the polymerisation of a monomer comprising at least one carboxylic acid group, such as acrylic acid and optionally a repeating unit derived from the polymerisation of a fluorinated monomer different from vinylidene fluoride (and more specifically, a repeating unit derived from the polymerisation of hexafluoropropene).

More particularly still, gelling polymers (FF) which can be used as polymer matrix of the electrodes are gelling polymers, whose aforementioned repeating units are derived from the polymerisation:
at least 70 mol % of a C₂-C₈, hydrogenated fluoroolefin, preferably, vinylidene fluoride;
from 0.1 to 15 mol % of a C₂-C₈, perfluoroolefin, preferably, hexafluoropropene; and
from 0.01 to 20 mol % of a monomer of the aforementioned formula (VIII), preferably, acrylic acid.

Moreover, the gelling polymer(s) (FF) advantageously have an intrinsic viscosity measured at 25° C. in N,N-dimethylformamide ranging from 0.1 to 1.0 L/g, preferably from 0.25 to 0.45 L/g.

More specifically, the intrinsic viscosity is determined by the equation below based on the drop duration, at 25° C., of a solution obtained by dissolving the concerned polymer in a solvent (N,N-dimethylformamide) at a concentration of about 0.2 g/dL using an Ubbelhode viscometer:

$$[ η ] = \frac{{η}_{sp} + Γ \cdot ln {η}_{r}}{( 1 + Γ ) \cdot c}$$

wherein:
n corresponds to the intrinsic viscosity (in dL/g);
c corresponds to the polymer concentration (in g/dL);
nᵣ corresponds to the relative viscosity, i.e. the ratio between the drop time of the solution and the drop time of the solvent;
nₛₚ corresponds to the specific viscosity, that is to say nᵣ−1;
r corresponds to an experimental factor set at 3 for the concerned polymer.

Apart from the nature of the active electrode material, the constituent ingredients of the positive electrode and the negative electrode may be identical.

Each electrode can also be associated with a current collector. The current collectors which are conventionally used in industry and in research laboratories in the field of lithium-ion batteries are metal collectors. Generally the used collectors are made of aluminum for the positive electrodes and for the negative electrode based on lithium titanium oxides such as Li₄Ti₅O₁₂, and of copper, nickel-plated copper, nickel or stainless steel for the negative electrodes based on graphite, silicon or silicon oxide, and mixtures thereof. The current collectors can also be carbon-based such as woven or non-woven carbon fibres, mats or felts based on carbon or derived from carbon such as, for example, carbon nanotubes. These carbon-based current collectors can be used at the positive electrode and the negative electrode. The current collectors may optionally be composites based on a polymer of the thermoplastic or thermosetting type, on which a metallisation is performed or a metal layer is deposited, to make it electron conductive.

The cells of the invention can be used alone to thus form a single-cell accumulator or be used in groups to form a multi-cell accumulator.

The invention thus also relates to an electrochemical accumulator comprising at least one electrochemical cell as defined above.

The accumulator may include a packaging intended, as its name suggests, to pack the different constituent elements of the accumulator.

This packaging may be flexible (in which case it is, for example, made from a laminated film comprising a frame in the form of aluminum foil which is coated, on the outer surface thereof, with a polyethylene terephthalate (PET) or polyamide layer and which is coated on, the inner surface thereof, with a of polypropylene (PP) or polyethylene (PE) layer) or else rigid (in which case, it is, for example, made of a light and inexpensive metal such as stainless steel, aluminum or titanium, or a thermoset resin such as an epoxy resin) depending on the targeted type of application.

The accumulators of the invention can be prepared by a method comprising a step of assembling the different basic elements, which are, for each cell, the separator, the positive electrode and the negative electrode.

The different basic elements can be prepared beforehand before assembly, in particular with regard to the separator, the following specific method of which is a subject of the invention, which method comprises:
a step of depositing in all or part of the cavities of the substrate as defined above a gelled polymer electrolyte composition;
a step of drying the composition thus deposited.

The gelled polymer electrolyte composition can be prepared prior to the deposition step.

In particular, when the gelled polymer electrolyte comprises a matrix comprising:
an organic portion comprising (or consisting of) at least one fluorinated polymer (F) comprising at least one repeating unit derived from the polymerisation of a fluorinated monomer and at least one repeating unit derived from the polymerisation of a monomer comprising at least one hydroxyl group, optionally in the form of a salt; and
an inorganic portion formed, in whole or in part, of one or more oxides of at least one element M selected from Si, Ti and Zr and combinations thereof;

the gelled polymer electrolyte further comprising a liquid electrolyte confined or trapped within the matrix,

the preparation of the gelled polymer electrolyte composition comprises the following steps:

(i) a step of contacting at least one fluorinated polymer (F) as defined above with:
at least one organometallic compound M1 of the following formula:

X₄₋ₘAYₘ

wherein m is an integer ranging from 1 to 3, A is a metal element selected from Si, Ti, Zr and combinations thereof, Y is a hydrolysable group and X is a hydrocarbon group comprising at least one isocyanate group —N═C═O;
a liquid electrolyte as defined above;
optionally, at least one organometallic compound M2 of the following formula:

A′Y′_{m′}

wherein m′ is an integer ranging from 1 to 4, A′ is a metal element selected from Si, Ti, Zr and combinations thereof, Y′ is a hydrolysable group;

(ii) a step of reacting at least one portion of the hydroxyl groups of the fluorinated polymer (F) with at least one portion of the compound M1 and, optionally, at least one portion of the compound M2, whereby a composition is obtained comprising a fluorinated polymer in which at least one portion of the hydroxyl groups are transformed into groups of formula —O—CO—NH—Z-AYₘX₃₋ₘ, wherein m, Y, A and X are as defined above and Z is a hydrocarbon group comprising, optionally, at least one group —N═C═O and optionally at least one portion of the hydroxyl groups is transformed into groups of formula —O-A′Y′_{m′-1} wherein A′, Y′ and m′ being as defined above;

(iii) a step of hydrolysis-condensation of the composition obtained in (ii) whereby the inorganic portion of the gelled polymer electrolyte is formed.

This type of method falls within the category of sol-gel type methods, since it involves organometallic compounds including hydrolysable groups and a step of hydrolysis-condensation of these compounds to form an inorganic portion. This type of method is described in particular in the patent application WO 2011/121078.

The hydrolysable group for the compound M1 is preferably selected so as to allow the formation of an —O-A- bond, this group possibly being selected from halogen atoms (preferably chlorine), alkoxy groups, acyloxy groups and hydroxyl groups.

More specifically, the compound M1 can correspond to the following formula:

O═C═N—R^{A}-A-(OR^{B})₃

wherein A is a metal element selected from Si, Ti, Zr and combinations thereof, R^{A} is a linear or branched hydrocarbon group comprising 1 to 12 carbon atoms and the R^{B}, identical or different, are hydrocarbon groups, more specifically, linear or branched alkyl groups and comprising 1 to 5 carbon atoms (for example, methyl or ethyl groups).

As examples of compound M1, mention may be made of trimethoxysilylmethylisocyanate, triethoxysilylmethylisocyanate, trimethoxysilylethylisocyanate, triethoxysilylethylisocyanate, trimethoxysilylpropylisocyanate, triethoxysilylpropylisocyanate, trimethoxysilylbutylisocyanate, triethoxysilylbutylisocyanate, trimethoxysilylpentylisocyanate, triethoxysilylpentylisocyanate, trimethoxysilylhexylisocyanate, triethoxysilylhexylisocyanate.

For the compound M2, in the same way as for compound M1, the hydrolysable group for the compound M2 is preferably selected so as to allow the formation of an —O-A- bond, this group possibly being selected from the halogen (preferably chlorine) atoms, alkoxy groups, acyloxy groups and hydroxyl groups.

As examples of compounds M2, when A is silicon, mention may be made of tetramethoxysilane (known by the abbreviation TMS) or tetraethoxysilane (known by the abbreviation TEOS).

The reaction step (ii) is carried out, generally, at a temperature ranging from 20 to 100° C., preferably from 20 to 90° C. and more preferably from 20 to 60° C. and, preferably, under inert gas atmosphere (such as an argon stream).

This reaction step (ii) and the subsequent step (iii) can be carried out in the presence of a condensation catalyst, which can be introduced during step (i).

The condensation catalyst can be an organotin compound.

It can be introduced, during step (i), in the amount of 0.1% to 50 mol %, preferably from 1 to 25 mol %, more preferably, from 5 to 15 mol % relative to the total number of moles of the compound M1 and, where appropriate, of the compound M2.

As examples of organotin compounds, mention may be made of dibutyltin dilaurate, dibutyltin oxide, tributyltin oxide, dioctyltin oxide, tributyltin chloride and tributyltin fluoride.

The hydrolysis-condensation step (iii) can be carried out at ambient temperature or by heating to a temperature below 100° C., the selection of temperature being dependent on the boiling point of the liquid electrolyte.

This hydrolysis-condensation step can be carried out in the presence of an acid catalyst, which can be added during one of steps (i) to (iii), for example, at 0.5 to 10% by mass, preferably from 1 to 5% by mass on the total basis of the composition.

This acid catalyst can in particular be an organic acid, such as formic acid.

The step of depositing the gelled polymer electrolyte composition on the substrate can be performed by any deposition techniques compatible with the deposition of gelled material and, advantageously, according to a slot die coating technique, the used die(s) possibly being in the form of distribution slots.

When the substrate is a grid, the deposition step can be carried out on both faces of the grid and, more specifically, by the die coating technique and, more particularly, according to a continuous in-line process. Specifically, in this case and as illustrated in FIG. 2 attached in the appendix, the substrate in the form of a grid (referenced 1) is disposed between a pair of drive rollers (referenced 3 and 5), the substrate when scrolling being in contact via the first face thereof (referenced 7) with a first die (referenced 9) delivering the gelled polymer electrolyte composition and a second die (referenced 11) delivering the gelled polymer electrolyte composition on a second face (referenced 13) which is opposite to the first face. The composition thus continuously deposited on both faces will penetrate, by gravity and capillarity, inside the grid mesh. This deposition on both sides allows ensuring good impregnation of the grid by the gelled polymer electrolyte composition and therefore ensuring, subsequently, a good contact between the gelled polymer electrolyte and the electrodes. This also allows being less constrained by the viscosity of the gelled polymer electrolyte composition, on the one hand, and the size of the mesh of the grid, on the other hand.

The positive and negative electrodes, when they are gelled electrodes, can be made by depositing a composition comprising the constituent ingredients of the electrodes (gelling polymer (FF), active material, liquid electrolyte and optionally at least one electron-conducting additive as defined above) on a substrate of the current collector type by a slot die coating technique, the used die(s) possibly being in the form of distribution slots, or else by printing or casting technique, followed by drying when necessary.

More specifically, the positive and negative electrodes can be prepared by a method comprising the following steps:

(i) the supply of a current collector type substrate;

(ii) providing a composition comprising:
at least one gelling polymer (FF) as defined above;
at least one electrode active material (it being understood that the electrode active material is a positive electrode active material, when the method relates to the preparation of a positive electrode or is a negative electrode active material, when the method relates to the preparation of a negative electrode);
a liquid electrolyte;
optionally, one or more electron-conducting additives;

(iii) applying the composition of step (ii) to the current collector type substrate of step (i), whereby it results in an assembly comprising the substrate coated with at least one layer of said composition; and

(iv) drying the assembly resulting from step (iii).

According to step (iii), the composition can be applied to a collector-type substrate by any type of application method, for example by casting, printing, coating, for example by roller or by die coating.

Step (iii) can typically be repeated one or more times, depending on the desired electrode thickness.

The drying of step (iv) is preferably carried out in line at a temperature which can, for example, range from 40° C. to 60° C.

The ingredients of the composition can correspond to the same variations as those already defined for these same ingredients within the scope of the description of the electrodes as such.

It should be noted that the composition advantageously comprises an organic solvent selected so as to allow the solubilisation of the gelling polymer(s) (FF), this organic solvent possibly being that of the liquid electrolyte or possibly being added in addition to the other ingredients mentioned above.

In order to guarantee uniform properties for all positive and negative electrodes of the accumulator, these can be from the same deposition layer (with a given composition for the positive electrode and a given composition for the negative electrode) deposited on a substrate composed of the constituent material of the different current collectors followed by an appropriate cutting of this substrate to provide the different current collectors coated with electrode(s).

Finally, the method for preparing the accumulators of the invention may comprise a step of placing a packaging around the accumulator, this positioning being able to be carried out by heat sealing in the case of a flexible packaging and by laser welding in the case of rigid packaging.

The invention will now be described in the light of the examples given below given by way of illustration and without limitation.

### BRIEF DESCRIPTION OF FIGURES

FIG. 1, already described above, is a photograph of a lozenge-shaped mesh grid which can be used for the separators of the invention.

FIG. 2, already described above, illustrates the die coating technique implemented for the preparation of a separator in accordance with the invention.

FIG. 3 illustrates, for formation cycles at C/20, the evolution of the voltage U (in V) as a function of the imposed current I (in A) over time t (in h) (respectively the curves a and b for the current and the curves c and d for the voltage) in the context of example 1.

FIG. 4 illustrates the evolution of the voltage U (in V) as a function of the discharge capacity C (in mAh) (curve a for the accumulator compliant with the invention and curve b for the non-compliant accumulator) in the context of Example 1.

FIG. 5 illustrates a tensile test (evolution of the force F (in N) as a function of the deformation D (in mm)) (curve a for the separator which is in accordance with the invention and curve b for the separator which is not in accordance with the invention) in the context of Example 1.

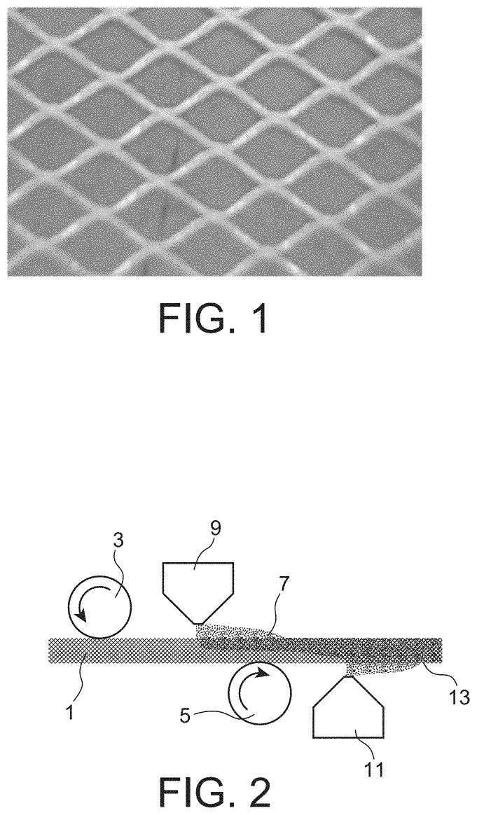

### DETAILED DISCUSSION OF PARTICULAR EMBODIMENTS

### Example 1

This example relates to the preparation of an accumulator comprising a separator in accordance with the invention.)

### 1° Preparation of the Separator in Accordance with the Invention

First, a gelled polymer electrolyte composition is prepared.

To do this, 10 g of a copolymer comprising repeating units derived from the polymerisation of vinylidene fluoride (VDF), 2-hydroxyethyl acrylate (HEA) and hexafluoropropene (HFP), this polymer being called PVdF-HEA-HFP(VDF 96.8 mol %-HEA 0.8 mol % and HFP 2.4 mol %) and having an intrinsic viscosity of 0.08 g/L are introduced into a double-walled synthesis reactor of 300 mL previously inerted with argon, then 67 mL of anhydrous acetone at 99.9% purity are added. The mixture is mechanically stirred for 30 min at 60° C. under an argon stream. Then 0.10 g of dibutyltin dilaurate (DBTL) are added and the resulting mixture is stirred for 90 minutes at 60° C. under an argon stream. 0.40 g of 3-(triethoxysilyl)propyl isocyanate (TSPI) are then added and the mixture is stirred for 90 minutes at 60° C. under an argon stream. 37.50 g of electrolyte (composed of a mixture (EC:PC) in mass proportion (1:1) (EC designating ethylene carbonate and PC designating propylene carbonate), vinylene carbonate (up to of 2% by mass) and a lithium salt LiPF₆ (1 M)) are added and the mixture is stirred for 30 min at 60° C. under an argon stream. 2.50 g of formic acid are then added and the mixture is stirred for 30 minutes at 60° C. under an argon stream. Finally 3.47 g of tetraethoxysilane are added and the mixture is stirred for 30 minutes at 60° C. under an argon stream.

The substrate used in this example is a substrate in the form of a polyetheretherketone grid with a thickness of 50 μm with a lozenge-shaped mesh. The long diagonal of the mesh measures 1.96 mm and the polymer strand has a width of 0.114 mm. The used PEEK grid is marketed under the reference 2PEEK4.5-077F from the supplier Dexmet Corporation.

The gelled electrolyte composition is deposited on one of the faces of the aforementioned substrate by a comma bar coating method in a dry atmosphere (Dew point: −20° C.) at a speed of 1 m/min. The composition thus deposited is subjected to drying in line in a 1.5 m long oven which is regulated between 40 to 60° C. depending on the drying zones.

The mechanical properties of the separator in accordance with the invention are evaluated on a Shimadzu AG-X brand traction bench equipped with a 50 N force sensor. The sample of the separator is pre-cut in the form of a width 4 mm and gauge length of 25 mm. The pulling speed is 50 mm/min. FIG. 5 shows that the tensile force of the separator according to the invention (a) is 2.53 N on average, while the tensile force of the separator in the absence of the polyetheretherketone substrate (b) is 0.18N. The tensile strength is therefore much higher for the separator according to the invention.

### B) Preparation of the Electrodes

For the preparation of the inks intended for the preparation of the electrodes, the same gelling polymer is used, whether for the positive electrode or the negative electrode. This is the polymer comprising repeating units derived from the polymerisation of vinylidene fluoride (96.7 mol %), acrylic acid (0.9 mol %) and hexafluoropropene (2.4 mol %) and having an intrinsic viscosity of 0.30 L/g in dimethylformamide at 25° C. This polymer is designated below by the terminology “Polymer 1”. This is incorporated into the ink intended for the manufacture of the electrodes in the form of an acetone solution in which 10% of polymer 1 has been dissolved at 60° C.

### *Preparation of the Negative Electrode

To do this, a mixture of 75% by mass of graphite (D₅₀=20 μm) and 25% by mass of graphite (D₅₀=3.5 μm) was added to the solution of Polymer 1 mentioned in the preceding paragraph, so that the mass ratio of (graphite/Polymer 1) is 90/10. To the resulting mixture, there was also added a liquid electrolyte composed of a mixture (EC:PC) in mass proportion (1:1) (EC designating ethylene carbonate and PC designating propylene carbonate), vinylene carbonate (up to 2% by mass) and a lithium salt LiPF₆ (1 M). The liquid electrolyte was added so as to obtain a mass ratio (M_{electrolyte}/(M_{electrolyte}+M_{polymer 1}))×100 equal to 75%.

The whole placed in the closed tank of 500 mL of a mixer of the disperser type, in order to avoid the evaporation of acetone, was mixed for 20 minutes at 4000 revolutions per minute in a dry atmosphere (Dew point: −20° C.).

This ink is then deposited on a copper current collector by a comma bar coating method in a dry atmosphere (dew point −20° C.) at a speed of 1 m/min. The composition thus deposited is subjected to drying in line in a 1.5 m long oven regulated between 40 to 60° C. according to the drying zones. The resulting layer constituting a negative electrode was die-cut to obtain a square electrode area of 17.22 cm² (41.5 mm*41.5 mm).

### *Preparation of the Positive Electrode

To do this, a mixture of 50% by mass of carbon black C-NERGY® C65 and 50% by mass of carbon fibres obtained in the vapor phase called “VGCF fibres” and LiNi_{1/3}Mn_{1/3}Co_{1/3}O₂ (called NMC) was added to the solution of Polymer 1 mentioned in the paragraph above so that the mass ratio of ((VGCF+C65+NMC)/polymer 1) was 92.8/7.2 with a mass ratio of (VGCF+C65)/NMC equal to 7.7/92.3. To the resulting mixture, there was also added a liquid electrolyte composed of a mixture (EC:PC) in mass proportion (1:1) (EC designating ethylene carbonate and PC designating propylene carbonate), vinylene carbonate (up to 2% by mass) and a lithium salt LiPF₆ (1 M). The liquid electrolyte was added so as to obtain a mass ratio (M_{electrolyte}/(M_{electrolyte}+M_{polymer 1}))×100 equal to 85.7%.

The whole placed in the closed tank of 500 mL of a mixer of the disperser type in order to avoid the evaporation of the acetone was mixed for 30 minutes at 4000 revolutions per minute in a dry atmosphere (Dew point −20° C.).

This ink is then deposited on an aluminum current collector by a comma bar coating method in a dry atmosphere (Dew point −20° C.) at a speed of 1 m/min. The composition thus deposited is subjected to drying in line in a 1.5 m long oven regulated between 40 to 60° C. according to the drying zones. The resulting layer constituting a positive electrode was die-cut to obtain a square electrode area of 16 cm² (40 mm*40 mm).

### 3-Preparation of the Accumulator and Results

The separator is brought into contact with the negative electrode mentioned above, then the positive electrode is stacked on this assembly.

The stack is packed in a flexible sachet of the “coffee bag” type then hermetically sealed by heat sealing.

The characteristics of the accumulator in terms in particular of nominal voltage, cycling terminals, surface capacity and estimated practical capacity are set out in the table below in comparison with a similar accumulator, prepared using the same inks for the formation of the electrodes on a gelled polymer electrolyte film as described above, but said film not being impregnated on a polyetheretherketone substrate.

The table below presents comparative results in terms of nominal voltage, cycling terminals, surface capacity and estimated practical capacity.

| Characteristics of the | In accordance with | Not in accordance |
|---|---|---|
| accumulator | the invention | with the invention |
| Nominal voltage (V) | 3.65 | 3.65 |
| Cycling terminals (V) | 2.8-4.15 | 2.8-4.15 |
| Mass of active material (mg) | 238.95 | 244.36 |
| Basis weight of AM (mg/cm²) | 14.93 | 15.27 |
| Surface capacity (mAh/cm²) | 29 | 2.13 |
| Estimated practical capacity | 33 | 34 |
| (mAh) | | |

It emerges from this table that the accumulator which is in accordance and the accumulator which is not in accordance with the invention have similar characteristics, which allow better comparing their electrochemical performances.

FIG. 3 illustrates, for formation cycles at C/20, the evolution of the voltage U (in V) as a function of the imposed current I (in A) over time t (in h) (respectively the curves a and b for the imposed current of the accumulator which is in accordance with the invention and the accumulator which is not in accordance with the invention and the curves c and d for the evolution of the voltage for the accumulator which is in accordance with the invention and the accumulator which is not in accordance with the invention). It shows that the charge and discharge profiles during the formation cycles at C/20 are similar between the cell including a separator which is in accordance with the invention compared to that which is not in accordance with the invention. Only the charging and discharging times are slightly different.

FIG. 4 illustrates the evolution of the voltage U (in V) as a function of the discharge capacity C (in mAh) (curve a for the accumulator which is in accordance with the invention and curve b for the non-compliant accumulator). It shows that the measured capacities are close to the estimated capacities listed in the table above and that the presence of a separator in accordance with the invention does not alter these properties.

FIG. 5 illustrates a tensile test (evolution of the force F (in N) as a function of the deformation D (in mm)) (curve a for the separator which is in accordance with the invention and curve b for the separator which is not in accordance with the 'invention). It demonstrates that the mechanical properties of the separator which is in accordance with invention are reinforced compared to the separator which is not in accordance with the invention. Indeed, the tensile strength is much higher when the substrate of the gelled polymer electrolyte is used.

1. A separator for an electrochemical accumulator comprising a substrate provided with cavities, said substrate consisting of one or more polymers, at least one of which is a polymer from the family of polyaryletherketones, all or part of said cavities being filled in whole or in part by a gelled polymer electrolyte, wherein the gelled polymer electrolyte comprises:
(A) a matrix comprising:
(A-1) an organic portion comprising at least one fluorinated polymer (F) comprising at least one repeating unit derived from the polymerisation of a fluorinated monomer and at least one repeating unit derived from the polymerisation of a monomer comprising at least one hydroxyl group, optionally in the form of a salt; and
(A-2) an inorganic portion formed, in whole or in part, of one or more oxides of at least one element M selected from Si, Ti and Zr and combinations thereof; and
(B) a liquid electrolyte confined or trapped within the matrix.

2. The separator according to claim 1, wherein the substrate consists only of one or more polymers from the family of polyaryletherketones.

3. The separator according to claim 1 or 2, wherein the polyaryletherketones are polymers comprising repeating units, of which more than 50 mol % of said repeating units are repeating units comprising an —Ar—C(O)—Ar′-group, wherein Ar and Ar′, identical or different from each other, are aromatic groups, these units being called units (R_{pAEK}).

4. The separator according to claim 3, wherein the units (R_{PAEK}) are selected from the group consisting of the units of formulas (J-A) to (J-O) as defined below: 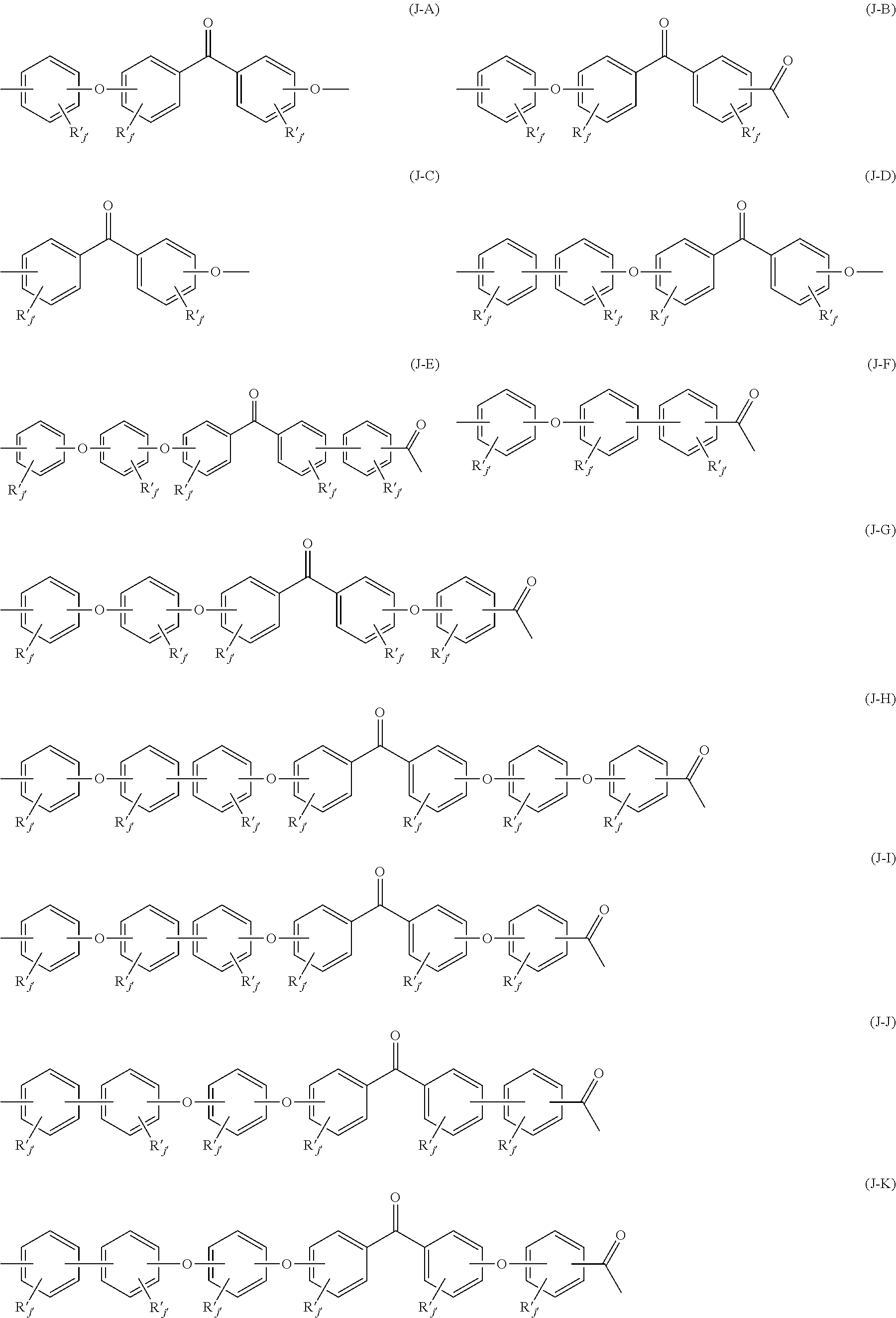 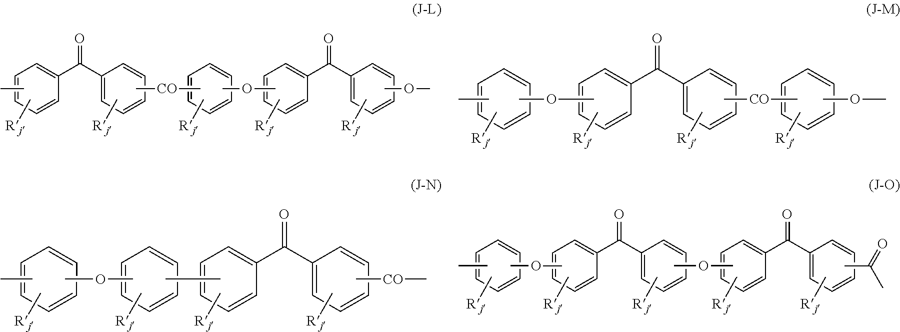
wherein:
each R′, identical or different, is selected from the group consisting of halogen atoms, alkyl, alkylvinyl, alkenyl, alkynyl, aryl, ether, thioether, carboxylic acid, ester, amide, imide, sulphonate, phosphonate, alkali or alkaline earth metal alkylphosphonate, amine and quaternary ammonium groups;
j′ is zero or an integer ranging from 1 to 4.

5. The separator according to claim 4, wherein j′ is equal to zero.

6. The separator according to any one of claims 3 to 5, wherein the repeating units (R_{PAEK}) are selected from those of formulas (J′-A) to (J′-O) as defined below:

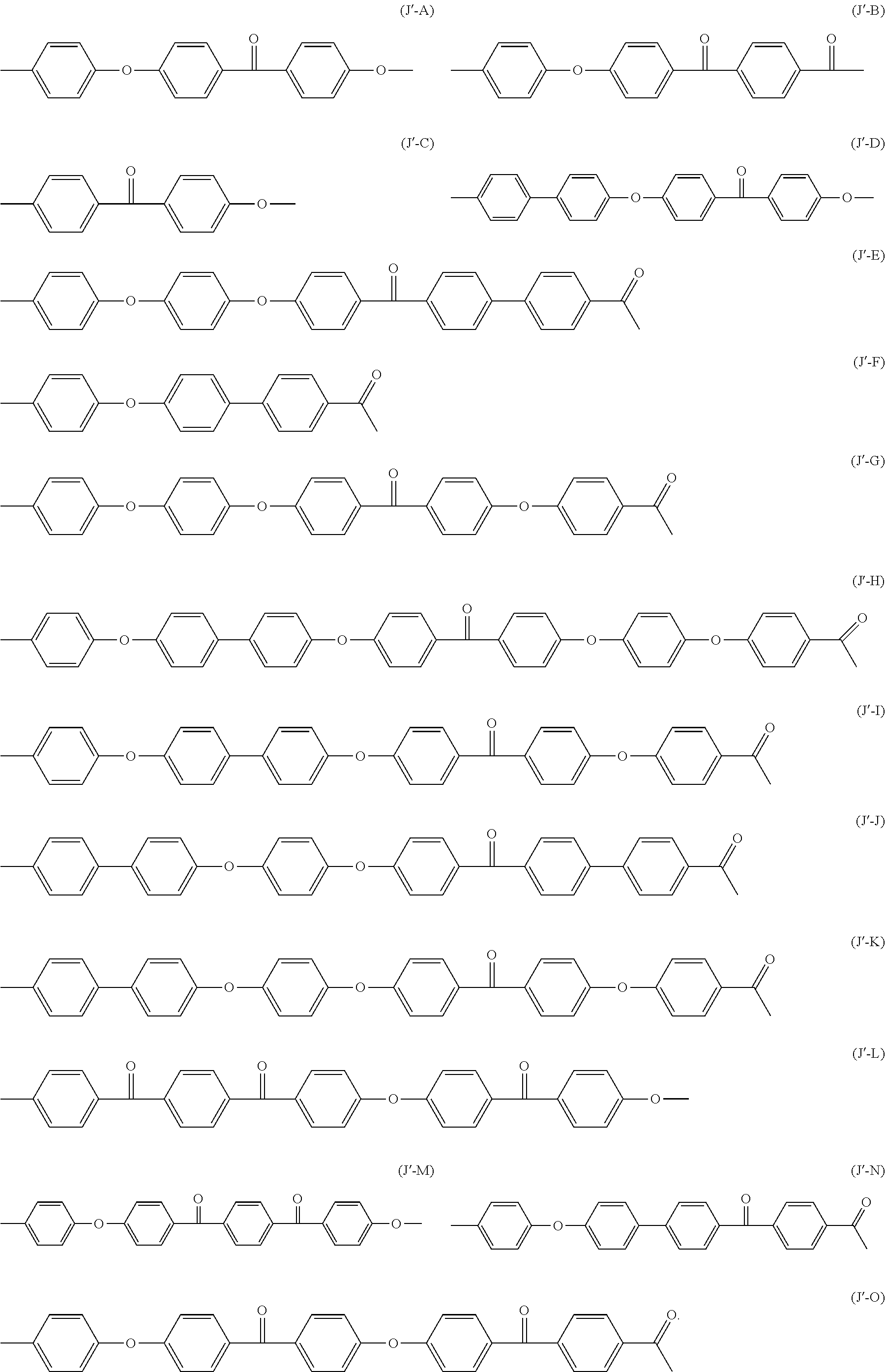

7. The separator according to any one of the preceding claims, wherein the substrate is a polyetheretherketone substrate.

8. The separator according to any one of the preceding claims, wherein the substrate is in the form of a grid resulting from an interlacing of polymer strands.

9. The separator according to any one of the preceding claims, wherein the substrate is in the form of a grid having a lozenge-shaped mesh.

10. The separator according to any one of the preceding claims, wherein the gelled polymer electrolyte further occupies all or part of the surface of the substrate in the form of a layer.

11. The separator according to any one of the preceding claims, wherein the fluorinated polymer (F) comprises, as repeating units derived from the polymerisation of a fluorinated monomer, a repeating unit derived from the polymerisation of a monomer from the class of C₂-C₈ perfluoroolefins, such as hexafluoropropene and a repeating unit derived from the polymerisation of a monomer from the class of C₂-C₈ hydrogenated fluoroolefins.

12. The separator according to any one of the preceding claims, wherein the repeating unit(s) derived from the polymerisation of a monomer comprising at least one hydroxyl group, optionally in the form of a salt, are one or more repeating units derived from the polymerisation of a monomer of formula (I) below: 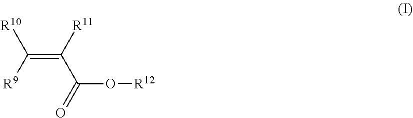
wherein R⁹ to R¹¹ represent, independently of each other, a hydrogen atom or a C₁-C₃ alkyl group and R¹² is a C₁-C₅ hydrocarbon group comprising at least one hydroxyl group.

13. The separator according to any one of the preceding claims, wherein the liquid electrolyte trapped within the matrix is an ion-conducting electrolyte comprising at least one organic solvent, at least one metal salt and optionally a compound from the family of vinyl compounds.

14. A method for preparing a separator as defined according to claim 1, comprising the following steps:
a step of depositing, in all or part of the cavities of the substrate, a gelled polymer electrolyte composition;
a step of drying the composition thus deposited.

15. The preparation method according to claim 14, wherein, when the substrate is a grid, the deposition step is carried out on both faces of the grid.

16. The preparation method according to claim 14 or 15, wherein the deposition step is carried out by the die coating technique.

17. An electrochemical cell for electrochemical accumulator comprising a positive electrode, a negative electrode and a separator as defined according to any one of claims 1 to 13 which is interposed between the positive electrode and the negative electrode.

18. The electrochemical cell for an electrochemical accumulator according to claim 17, wherein the negative electrode and the positive electrode comprise a liquid electrolyte trapped within a polymer matrix.

19. The electrochemical cell according to claim 18, wherein the polymer matrix is made of at least one gelling polymer (FF), the gelling polymer(s) (FF) being selected from fluorinated polymers comprising at least one repeating unit derived from the polymerisation of a fluorinated monomer and at least one repeating unit derived from the polymerisation of a monomer comprising at least one carboxylic acid group, optionally in the form of a salt.

20. An electrochemical accumulator comprising at least one electrochemical cell as defined according to any one of claims 17 to 19.
